(19) United States
(12) Patent Application Publication
(10) Pub. No.: US 2004/0032605 A1
(43) Pub. Date: Feb. 19, 2004

(54) Monitoring patterns of use for peripheral device access

(76) Inventor: Laurent A. Regimbal, Round Rock, TX (US)

Correspondence Address: HEWLETT-PACKARD COMPANY, Intellectual Property Administration, P.O. Box 272400, Fort Collins, CO, 80527-2400, US

(21) Appl. No.: 10/219,853

(22) Filed: Aug. 14, 2002

(51) Int. Cl. G06F 1/32; G06F 1/26; G06F 11/30; G06F 3/00; G06F 13/10

(52) U.S. Cl. 358/1.13; 358/1.15; 710/10; 713/320; 358/406; 719/327

(57) ABSTRACT

Patterns of use with respect to a peripheral device to optimize future user and application interactions with the device are monitored. Specifically, a pattern of use is identified and recorded with respect to the peripheral device. User action is detected that corresponds to the pattern of use; the action indicates a potential use of the peripheral device that is independent of an actual use of the peripheral device. Responsive to detecting the action, the peripheral device is readied for use, for example, by causing the device to warm up and/or perform a calibration cycle.

### TECHNICAL FIELD

The described subject matter pertains to managing image forming peripheral devices.

### BACKGROUND

With an image reproduction system such as a laser printer, it is not a simple matter to consistently produce high quality images. This is because characteristic variations in photo sensitivity of photoreceptors and toner typically occur over time with quantity of use and changes in operating environment (e.g., changes in temperature, humidity, and the like). Thus, image reproduction systems often implement automatic calibration procedures to monitor and adjust such characteristic variations (e.g., to factory default settings) to produce images with colors having the intended color quality and color matching (e.g., hue, lightness, and colorfulness).

Such calibration procedures may be performed by an image reproduction system at any of a number of different times. For example, such calibration procedures may be performed after a system is powered on, responsive to a system “waking-up” from a power-save mode, after the system has printed a predetermined number of pages (i.e., a page-count initiated calibration cycle), and so on. Depending on the particular calibration procedures performed by the system, a system calibration cycle may take a substantial amount of time, possibly inconveniencing system users. (The actual amount of time of a calibration cycle is typically device dependent).

For example, it may be inconvenient for a user that is retrieving a print job to find out that the print job is not complete or has not even begun printing yet because the printer is warming up or in the middle of performing a calibration cycle. This may be the result of the printer having previously been in a power-save mode and having been “woken” up in response to receiving the user's, or for that matter, someone else's print request. Calibration cycles can also be caused by the triggering of a page-count initiated calibration cycle (e.g., a printer may calibrate after printing 50 to 100 pages to keep the toner characteristics stable), which could occur in the middle of a print job. In such a situation, the user must wait for the system to complete warming-up and/or calibrating before receiving the print job.

The following described subject matter addresses these and other problems associated with traditional systems and procedures to manage image reproduction systems.

### SUMMARY

The described subject matter monitors patterns of use with respect to a peripheral device to optimize future user and application interactions with the device. Specifically, a pattern of use is identified and recorded with respect to the peripheral device. User action is detected that corresponds to the pattern of use; the action indicates a potential use of the peripheral device that is independent of an actual use of the peripheral device. Responsive to detecting the action, the peripheral device is readied for use, for example, by causing the device to warm up and/or perform a calibration cycle.

### BRIEF DESCRIPTION OF THE DRAWINGS

The same numbers are used throughout the drawings to reference like features and components.

FIG. 1 shows aspects of an exemplary data structure for storing identified patterns of use with respect to a peripheral device such as a printer, a scanner, a facsimile, or the like.

FIG. 2 shows aspects of an exemplary system to determine and utilize patterns of peripheral device use to ready the device for use anticipating actual use of the device.

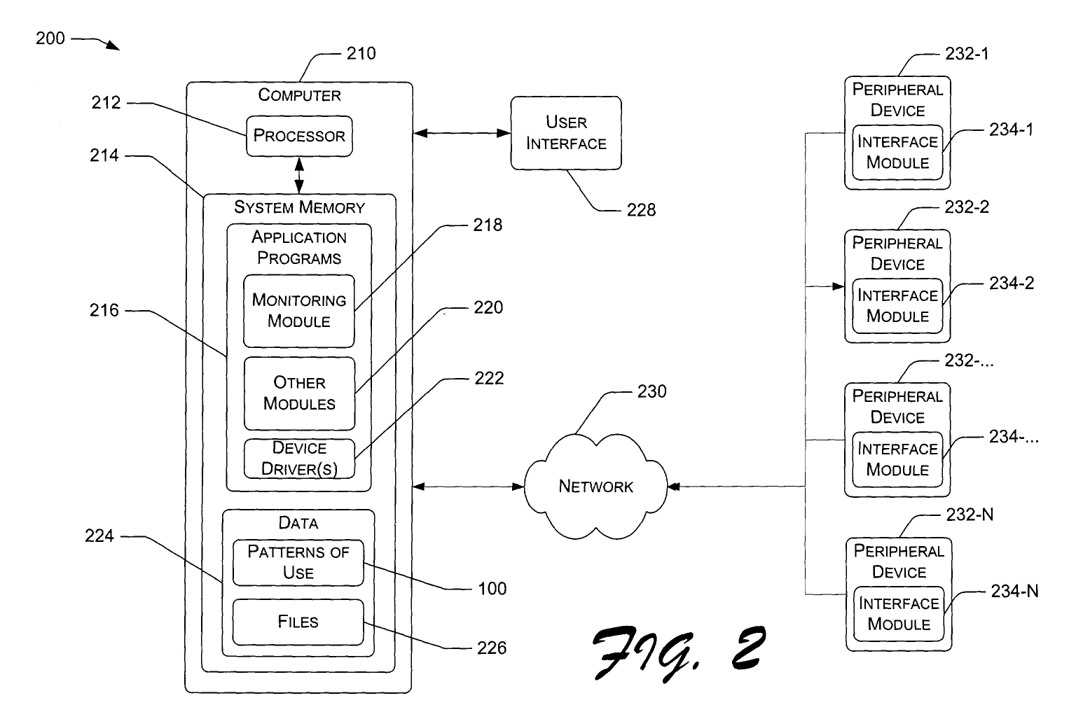

FIG. 3 shows aspects of an exemplary procedure to determine and utilize patterns of peripheral device use to ready the device for use anticipating actual use of the device.

### DETAILED DESCRIPTION

### Overview

As discussed in the background section, conventional systems and procedures for preparing a peripheral device for use (e.g., calibrating the device) may result in the peripheral device not being ready to use when a user submits a task such as a print job to the peripheral device. Thus, such conventional techniques may cause delay and frustration when a user goes to retrieve the results of the submitted task, only to find that the print job is not ready because the peripheral device is just warming up or in the middle of a calibration cycle.

In contrast to such conventional systems and procedures, the following described subject matter increase the likelihood that a peripheral device will be ready for use when a user submits a task to the peripheral device. This is because the described subject matter keeps track of a user's patterns of use with respect to the peripheral device. For instance, when a user performs an action such as opening a computer application, opening a document, and/or the like, these tracked patterns are evaluated to determine whether or not the user typically utilizes the peripheral device in a typical course of events that follow the performed action. If so the peripheral device is prepared in advance (e.g., warmed-up, calibrated, etc.) for any such potential use. In this manner, the likelihood that the peripheral device will be ready for use when a user is ready to submit a task to the peripheral is substantially increased.

### Exemplary Data Structures

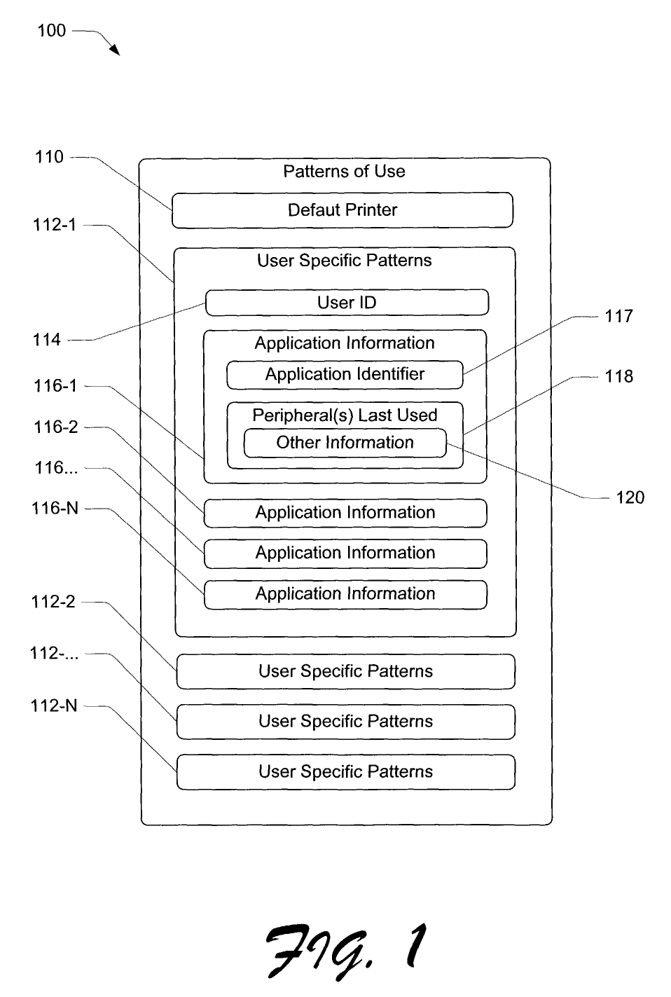

FIG. 1 is a block diagram that shows an exemplary data structure 100 for storing identified patterns of use and/or application specific use with respect to a peripheral device, for example, such as a printer, a scanner, a facsimile, and so on. In this example, the data fields of data structure 100 correspond to printer or image forming device data fields, although other names can be used if the particular device is not a printer to more closely track the particular type of image forming device that is being used.

For instance, the data structure 100 includes a default printer data field 110, and one or more user specific pattern data fields 112. The default printer data field indicates a name of a particular system-wide default printer that can be used by computer program applications to print. For example, the default printer is a printer that is used if a user chooses the “Print” command menu item in an application without first specifying which specific printer to use with the application. Typically a system has only one default printer; which is the printer that an individual or organization uses most often. Operating systems typically provide for programmatic access to information that corresponds to how to access a default printer.

Each pattern data field 112 includes a user ID data field 114, and one or more application 116 data fields. The user ID data field is used to uniquely identify a specific user. Such unique identification can be any type of identification such as a username and/or password combination that is supplied by a user when logging onto a computer system, or a domain name of a device on a network, etc.

Each application data field 116 includes an application identifier 117 data field, and one or more last peripheral device 118 data fields. The application identifier stores an indication of an application program such as its name, or other substantially unique identifier. These applications will be applications (e.g., word processors, spreadsheets, Web browsers, etc.) that have been accessed by the particular user and/or machine.

A last peripheral device 118 data field uniquely identifies a peripheral device such as a printer, facsimile device, and so on, that was accessed from an identified application 117. A peripheral device can be uniquely identified in a number of different ways such as through a unique name, a serial number, an Internet Protocol (IP) address, a port number, a public or private network address mapping (e.g., in a private network that utilizes Network Address Translation), etc.

The peripheral last used 118 data field includes other information data field 120 to store information such as print media type (e.g., paper, transparencies, etc.), size (e.g., standard letter, A4, etc.), etc., that is specific to the peripheral device identified in the particular peripheral last used data field.

The peripheral device patterns of use can be system and application specific, rather than user/application specific. For instance, in this example, the pattern of use data structure 100 does not indicate patterns of peripheral device use information with respect to specific users (e.g., a user identified by user ID 114) of a computing device. Rather, the patterns of use correspond to peripheral device use patterns only with respect to particular computer program applications. To accomplish this, the described subject matter utilizes the application 116, the last peripheral device 118, and the other information 120 data fields, as discussed above.

### Exemplary System

FIG. 200 is a block diagram that shows an exemplary system 200 to determine and utilize patterns of peripheral device use to ready the device for use anticipating actual use of the device. The exemplary system is only an example of a suitable computing environment to implement the described subject matter and does not suggest any limitation as to the scope of the subject matter. The system includes a computing device 210 that is operatively coupled to one or more peripheral devices 232 such as one or more printers, scanners, facsimile machines, and so on.

The term “printer” includes, but is not limited to, laser printers, ink jet printers, dot matrix printers, dry medium printers, copiers, facsimile machines and plotters. Although specific examples may refer to one or more of these printers, such examples are not meant to limit the scope of the claims or the description, but are meant to provide a specific understanding of the described subject matter.

Each peripheral device 232 includes an interface module 234 for receiving communications from the computer 210, and also for responding to the received communications. Such computer initiated communications include, for example, a request to determine if the device is in a standby power mode, a request to determine a number of pages before a page initiated calibration cycle will be performed, and so on. Device responses to such computer communications include, for example, performing a number of procedures to warm up and/or perform a calibration cycle (e.g., in response to a request from the computer to determine if the device is in a standby power save mode), the communication of a page-count number to the computer from the device to indicate a number of pages that will be printed before the device performs a page initiated calibration cycle, etc.

The computing device 210 may be directly coupled to the peripheral device(s) 232, or the computing device may be operatively coupled to the peripheral device over a logical connection such as over a network 230 (e.g., the Internet, a Local Area Network (LAN), an organizational intranet, etc.).

The computing device 210 includes a processor 212 that is operatively coupled to a system memory 214. The system memory includes any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory card, a CD-ROM, and/or the like.

The processor 212 is configured to fetch and execute computer program instructions from program modules stored in application programs 216. Such application program modules include, for example, an operating system, a user interface, and other program modules such as monitoring module 218, other modules 220, and one or more device drivers 222. The processor 212 is also configured to fetch and/or store data from/into program data 224. Such fetched and/or stored data includes, for example, various data structures, files, and other data such as data from the peripheral device patterns of use table 100 of FIG. 1.

A user may enter commands and information (e.g., to open a program or a document) into the computer 210 through user interface 228. The user interface includes input devices such as a keyboard and/or a pointing device (e.g., a “mouse”). Other input devices may include a microphone, joystick, game pad, satellite dish, serial port, scanner, and so on. The user interface may also include a monitor or other type of display device for presenting aspects of computer program applications 216 that execute on the computer.

The monitoring module 118 keeps track of patterns of use with respect to a peripheral device 232. When a user performs an action such as opening a computer program 220 (e.g., a word processor, a Web browser, etc.), opening a document 226, etc, these tracked patterns are evaluated against data stored in the patterns of use data structure 100 to determine whether or not the user typically utilizes any one or more of the peripheral devices in a typical course of events that follow the performed action.

For example, when a computer program 220 accesses a device 232 (e.g., to print a document), the monitoring module 218 stores an indication of the program such as its name into the application indication 117 data field of FIG. 1, and also stores information to uniquely identify the accessed device 232 into the last peripheral device used 118 data field. Additionally, the monitoring module 218 stores other information that corresponds to patterns of access to the device in the other information data field 120. The other information can be any type of information such as the type of media (e.g., transparencies, A4 size paper, standard letter size paper, etc.) last printed, or most often printed at a printer device 232.

Optionally, the application 216 and peripheral device 232 access information is stored by the monitoring module 218 on a user-by-user basis. This means that rather than storing such information solely with respect to applications, the information is personalized by storing it with respect to specific users. Thus, when a particular user opens an application, the user's preferred peripheral device(s) with respect to the application is determined so that the device(s) are readied for use, anticipating actual use of the device(s) by the user.

To illustrate this, consider that a user opens a particular word processing computer program. Responsive to this, the monitoring module 218 evaluates information stored in the patterns of use 100 (see, also FIG. 1) data structure to determine which peripheral device(s) 232 (if any) is typically accessed by the user/application. (Techniques to determine when a user performs a particular operation such as opening a computer program or document are known.) If the program/user combination is not identified in the data structure, the monitoring module adds the program/user pattern of use information into the data structure and also performs the following procedures with respect to the default printer 110 of FIG. 1.

However, if the data structure 100 indicates a particular device that is typically accessed by the user/application, for example, indicating that the user typically prints to a specific imaging device such as the Hewlett Packard LaserJet® 4500 printer from the particular word processing application, that particular device(s) is the target of the following procedures.

Responsive to evaluating the data structure 100, the monitoring module 218 communicates a message to the target device(s) 232 to determine if it is ready to process a job from the user/application. (A device 232 can be accessed using a device driver 222, which is a program that enables the monitoring module to communicate with the peripheral device 232.) Responsive to receiving the message and if the device is in a power save mode, the device makes itself ready by warming-up and/or calibrating, or responds in a manner that communicates its present state to the monitoring module (e.g., sending a message back to the module, not responding for a predetermined amount of time since the status message was sent to the device, and/or the like). If the device responds by indicating that it is in a power save mode, or if the device does not automatically respond to the communication by putting itself into a ready mode, the monitoring module sends the device a subsequent “wake up” command causing the device to perform any device specific warm-up and/or calibration procedures.

If the monitor module 218 determines that the identified device 232 is out of order (e.g., a paper jam), the monitor module notifies a user of this condition (e.g., displaying a message in a dialog box) in anticipation of a future attempt to access the device. This provides the user not only notice that a particular device may need attention, but also provides the user with advance information that can be used to route any device specific requests to a different device.

If the user opens a document 226 in the application 220, the monitoring module 218 communicates with the device to determine if it performs page-count initiated calibration cycles, and if it does, the monitor module determines the number of pages that the device can process before its next page-count initiated calibration cycle. If the number of pages in the opened document will trigger the page-count initiated calibration when and if the document is submitted to the device for processing, the monitor module will cause the device to perform the calibration in anticipation of the document being submitted to the device. Additionally, if the document length is greater than the number of pages between calibration cycles, the calibration cycle is ignored. These aspects substantially reduce the possibility that a user will be required to wait for a calibration cycle to occur/complete after a job has been submitted to the device 232. (An additional benefit may be that a color document that is submitted to a printer for printing will have more consistent colors in the printed output. This is because a calibration cycle typically adjusts a number of print process parameters that generally affect the appearance of the print.)

If other information 120 of FIG. 1 indicates that a user normally uses a particular print media type such as transparencies when printing from an application, the monitor module 218 queries the printer to determine if the particular media type is loaded in one of the printer's media bins. The printers interface module 134 responds to the communication by forwarding a message to the computer 210 that indicates whether the media of choice is loaded in a media bin. If not, the monitor module notifies the user of this fact (e.g., using a dialog box, or the like) in advance of a print job actually being sent to the device.

If a printer 232 indicates that the particular media type is not available, the monitor module 218 queries other devices 232 to determine whether any of the other devices are available and loaded with the particular media type. If so, the monitor module provides this information to the user.

In this manner the system 200 records a user's tendencies with respect to peripheral device use and anticipates device requests based on these tendencies to provide the user with device specific information and/or ready the device for future use.

### Computer-Executable Instructions

The subject matter of the described arrangements and procedures is illustrated in the drawings as being implemented in a suitable computing environment. Although not required, the subject matter is described in the general context of computer-executable instructions, such as program modules that are executed by a computing device such as the host device 210. Program modules typically include routines, programs, objects, components, data structures, and the like, that perform particular tasks or implement particular abstract data types. Moreover, those skilled in the art will appreciate that the subject matter may be practiced with other computer system configurations, including multi-processor systems, microprocessor-based or programmable consumer electronics, network PCs, minicomputers, mainframe computers, and the like. The subject matter may also be practiced in distributed computing environments where tasks are performed by remote processing devices that are linked through a communications network. In a distributed computing environment, program modules may be located in both local and remote memory storage devices (computer-readable media).

### Exemplary Procedure to Optimize Peripheral Device Access

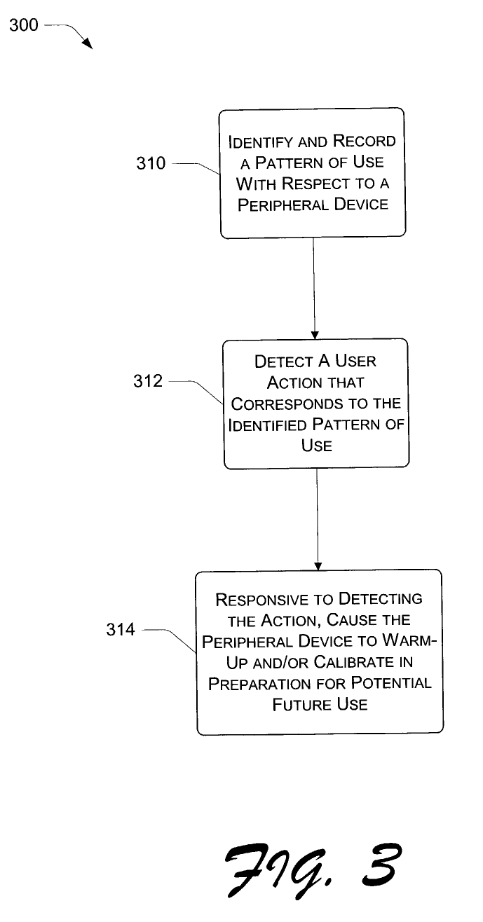

FIG. 3 is a flowchart diagram showing an exemplary procedure 300 to determine and utilize patterns of peripheral device use to ready the device for use anticipating actual use of the device. At block 310, the procedure identifies and records a pattern of use with respect to a peripheral device. At block 312, the procedure detects a user action such as the opening of an application, a document, and/or the like that corresponds to the identified pattern of use (see, block 310). At block 314, the procedure responds to detecting the user action (block 312) by readying the peripheral device for use in anticipation of actual use of the device by the user/application.

### Conclusion

The described subject matter provides for monitoring user patterns of use to optimize interactions with peripheral devices. Although the subject matter has been described in language specific to structural features and/or methodological operation, it is to be understood that the subject matter defined in the appended claims is not necessarily limited to the specific features or operation described. Rather, the specific features and operations are disclosed as exemplary embodiments of the claimed invention.

1. A method comprising the steps of:
identifying a pattern of use with respect to a peripheral device;
detecting a user action that corresponds to the pattern of use, the action indicating a potential use of the peripheral device that is independent of an actual use of the peripheral device; and
responsive to detecting the action, readying the peripheral device for use.

2. A method as recited in claim 1, wherein the step of readying the peripheral device for use further comprises communicating a message to the device to notify the device to warm-up and/or perform a calibration cycle.

3. A method as recited in claim 1, wherein the device is in a power-save state, and wherein readying the peripheral device for use further comprises waking the device up from the power-save state such that the device is able to warm up and/or perform a calibration cycle.

4. A method as recited in claim 1, wherein the user action is opening a particular computer program application.

5. A method as recited in claim 1, wherein the user action is accessing a document, the peripheral device is a printer, and wherein readying the peripheral device for use further comprises:
responsive to detecting the user action:
identifying a number of pages in the document; and
identifying a page-count number at which the printer will perform a page-count initiated calibration cycle;
determining that printing the document will cause the printer to perform the page-count initiated calibration cycle, the determining being based on the number of pages and the page count number; and
responsive to determining that the printer will perform the page-count initiated calibration cycle, causing the device to perform the calibration independent of printing the document.

6. A method as recited in claim 1, wherein the user action is instantiating a computer program, and wherein the method further comprises:
responsive to readying the peripheral device, automatically determining that the peripheral device is not available for use; and
upon determining that the peripheral device is not available for use, notifying a user that the peripheral device is not available for use.

7. A method as recited in claim 1, wherein the user action is instantiating a computer program, the peripheral device is a printing device, wherein the pattern of use further comprises an indication that a particular type of print media is typically used to print from the computer program, and wherein readying the peripheral device further comprises:
automatically determining whether the particular type of print media are loaded in the printing device; and
upon determining that the particular type of print media are not loaded in the printing device, notifying a user that the particular type of print media are not loaded in the printing device.

8. A method as recited in claim 7, wherein notifying a user that the particular type of print media are not loaded in the printing device further comprises:
automatically identifying a different peripheral device with the particular type of print media loaded; and
informing the user that the different peripheral device has the particular type of print media loaded.

9. A computer-readable medium comprising computer-executable instructions for:
identifying a pattern of use with respect to a peripheral device;
detecting a user action that corresponds to the pattern of use, the action indicating a potential use of the peripheral device that is independent of an actual use of the peripheral device; and
responsive to detecting the action, readying the peripheral device for use.

10. A computer-readable medium as recited in claim 9, wherein the instructions for readying the peripheral device for use further comprise instructions for communicating a message to the device to notify the device to warm-up and/or perform a calibration cycle.

11. A computer-readable medium as recited in claim 9, wherein the device is in a power-save state, and wherein the instructions for readying the peripheral device for use further comprise instructions for waking the device up from the power-save state such that the device is able to warm up and/or perform a calibration cycle.

12. A computer-readable medium as recited in claim 9, wherein the user action is opening a particular computer program application.

13. A computer-readable medium as recited in claim 9, wherein the user action is accessing a document, the peripheral device is a printer, and wherein instructions for readying the peripheral device for use further comprise instructions for:
responsive to detecting the user action:
identifying a number of pages in the document;
identifying a page-count number at which the printer will perform a page-count initiated calibration cycle;
determining that printing the document will cause the printer to perform the page-count initiated calibration cycle, the determining being based on the number of pages and the page count number; and
responsive to determining that the printer will perform the page-count initiated calibration cycle, causing the device to perform the calibration independent of printing the document.

14. A computer-readable medium as recited in claim 9, wherein the user action is instantiating a computer program, and wherein the computer-executable instructions further comprise instructions for:
responsive to readying the peripheral device, automatically determining that the peripheral device is not available for use; and
upon determining that the peripheral device is not available for use, notifying a user that the peripheral device is not available for use.

15. A computer-readable medium as recited in claim 9, wherein the user action is instantiating a computer program, the peripheral device is a printing device, wherein the pattern of use further comprises an indication that a particular type of print media is typically used to print from the computer program, and wherein the instructions for readying the peripheral device further comprise instructions for:
automatically determining whether the particular type of print media are loaded in the printing device; and
upon determining that the particular type of print media are not loaded in the printing device, notifying a user that the particular type of print media are not loaded in the printing device.

16. A computer-readable medium as recited in claim 15, wherein the instructions for notifying a user that the particular type of print media are not loaded in the printing device further comprise instructions for:
automatically identifying a different peripheral device with the particular type of print media loaded; and
informing the user that the different peripheral device has the particular type of print media loaded.

17. A device for monitoring patterns of use with respect to a peripheral device to optimize interaction with the peripheral device, the device comprising:
a memory comprising executable instructions and;
a processor coupled to the memory, the processor being configured to fetch and execute the computer executable instructions and data from the memory, the computer-executable instructions comprising instructions for:
identifying a pattern of use with respect to a peripheral device;
detecting a user action that corresponds to the pattern of use, the action indicating a potential use of the peripheral device that is independent of an actual use of the peripheral device; and
responsive to detecting the action, readying the peripheral device for use.

18. A device as recited in claim 17, wherein the instructions for readying the peripheral device for use further comprise instructions for communicating a message to the device to notify the device to warm-up and/or perform a calibration cycle.

19. A device as recited in claim 17, wherein the device is in a power-save state, and wherein the instructions for readying the peripheral device for use further comprise instructions for waking the device up from the power-save state such that the device is able to warm up and/or perform a calibration cycle.

20. A device as recited in claim 17, wherein the user action is opening a particular computer program application.

21. A device as recited in claim 17, wherein the user action is accessing a document, the peripheral device is a printer, and wherein instructions for readying the peripheral device for use further comprise instructions for:
responsive to detecting the user action:
identifying a number of pages in the document;
identifying a page-count number at which the printer will perform a page-count initiated calibration cycle;
determining that printing the document will cause the printer to perform the page-count initiated calibration cycle, the determining being based on the number of pages and the page count number; and
responsive to determining that the printer will perform the page-count initiated calibration cycle, causing the device to perform the calibration independently of printing the document.

22. A device as recited in claim 17, wherein the user action is instantiating a computer program, and wherein the computer-executable instructions further comprise instructions for:
responsive to readying the peripheral device, automatically determining that the peripheral device is not available for use; and
upon determining that the peripheral device is not available for use, notifying a user that the peripheral device is not available for use.

23. A device as recited in claim 17, wherein the user action is instantiating a computer program, the peripheral device is a printing device, wherein the pattern of use further comprises an indication that a particular type of print media is typically used to print from the computer program, and wherein the instructions for readying the peripheral device further comprise instructions for:
automatically determining whether the particular type of print media are loaded in the printing device; and
upon determining that the particular type of print media are not loaded in the printing device, notifying a user that the particular type of print media are not loaded in the printing device.

24. A device as recited in claim 17, wherein the instructions for notifying a user that the particular type of print media are not loaded in the printing device further comprise instructions for:
automatically identifying a different peripheral device with the particular type of print media loaded; and
informing the user that the different peripheral device has the particular type of print media loaded.

25. A device for monitoring patterns of use with respect to a peripheral device to optimize interaction with the peripheral device, the device comprising processing means for:
identifying a pattern of use with respect to a peripheral device;
detecting a user action that corresponds to the pattern of use, the action indicating a potential use of the peripheral device that is independent of an actual use of the peripheral device; and
responsive to detecting the action, readying the peripheral device for use.

26. A device as recited in claim 25, wherein the user action is opening a particular computer program application.

27. A device as recited in claim 25, wherein the means for readying the peripheral device for use further comprise means for communicating a message to the device to notify the device to warm-up and/or perform a calibration cycle.

28. A device as recited in claim 25, wherein the device is in a power-save state, and wherein the means for readying the peripheral device for use further comprise means for waking the device up from the power-save state such that the device is able to warm up and/or perform a calibration cycle.

29. A device as recited in claim 25, wherein the user action is accessing a document, the peripheral device is a printer, and wherein the processing means for readying the peripheral device for use further comprise means for:
responsive to detecting the user action:
identifying a number of pages in the document;
identifying a page-count number at which the printer will perform a page-count initiated calibration cycle;
determining that printing the document will cause the printer to perform the page-count initiated calibration cycle, the determining being based on the number of pages and the page count number; and
responsive to determining that the printer will perform the page-count initiated calibration cycle, causing the device to perform the calibration independently of printing the document.

30. A device as recited in claim 25, wherein the user action is instantiating a computer program, and wherein the processing means further comprise means for:
responsive to readying the peripheral device, automatically determining that the peripheral device is not available for use; and
upon determining that the peripheral device is not available for use, notifying a user that the peripheral device is not available for use.

31. A device as recited in claim 25, wherein the user action is instantiating a computer program, the peripheral device is a printing device, wherein the pattern of use further comprises an indication that a particular type of print media is typically used to print from the computer program, and wherein the means for readying the peripheral device further comprise means for:
automatically determining whether the particular type of print media are loaded in the printing device; and
upon determining that the particular type of print media are not loaded in the printing device, notifying a user that the particular type of print media are not loaded in the printing device.

32. A device as recited in claim 25, wherein the means for notifying a user that the particular type of print media are not loaded in the printing device further comprise means for:
automatically identifying a different peripheral device with the particular type of print media loaded; and
informing the user that the different peripheral device has the particular type of print media loaded.
